(19) United States
(12) Patent Application Publication
(10) Pub. No.: US 2008/0263158 A1
(43) Pub. Date: Oct. 23, 2008

(54) Method and Apparatus for Instant Messaging

(76) Inventors: Carlos del Cacho, Madrid (ES); Michel Louis Francis Grech, London (GB); Kumar Venkata Vemuri, Naperville, IL (US)

Correspondence Address: PATTERSON & SHERIDAN, LLP/;LUCENT TECHNOLOGIES, INC, 595 SHREWSBURY AVENUE, SHREWSBURY, NJ, 07702, US

(21) Appl. No.: 11/737,202

(22) Filed: Apr. 19, 2007

(51) Int. Cl. G06F 15/16

(52) U.S. Cl. 709/206

(57) ABSTRACT

A method and apparatus for instant messaging capable of an automatic response mode with enhanced reply options. In the automatic response mode, upon receiving a message from a sender, a terminal selects a reply message from a plurality of messages in accordance with at least one predetermined criterion, and responds to the sender with the selected reply message.

### BACKGROUND OF THE INVENTION

1. Field of the Invention

The invention relates generally to a method and apparatus for instant messaging, and more specifically, for providing automated reply messages that can be customized for certain users or situations.

2. Description of Related Art

Instant Messaging (IM) is a widely used application that leverages the presence enabler. It allows users to communicate over text or rich media, with the advertised presence of their contacts serving as a guide as to when to initiate communications and in what format.

In existing IM or other presence-enabled services, presence or availability indicators (or status messages) are used to inform IM users regarding the status of a particular IM user. However, typical status messages are displayed in a non-selective manner to all senders, and usually contain only limited information, which may result in uncertainties regarding the actual status of the particular individual. For example, when an IM user trying to reach another user receives a “busy” status message, it is not clear whether the other user is busy because he is physically away from the office, or whether he is at the desk taking a phone call and thus, may be able to respond to urgent IMs. Although status messages with more detailed or customized information are available with certain services, enhancements to these status notifications are still needed to provide improved experience and added flexibility for IM users.

### SUMMARY OF THE INVENTION

The present invention addresses the need for enhanced reply options and improved flexibility by providing a method and system of instant messaging that provides an automatic response mode with customizable reply messages.

One embodiment provides a method of instant messaging that includes: receiving at a terminal a first message from a sender to a recipient; the terminal capable of operating in one of two response modes, which include an automatic mode and a manual mode; selecting one of the two response modes based on at least one factor; and responding to the sender by the selected response mode. The automatic response mode includes: (a) selecting a reply message from a plurality of messages in accordance with at least one predetermined criterion; and (b) responding to the sender with the reply message; wherein steps (a) and (b) are performed automatically by the terminal upon receiving the first message.

Another embodiment provides a method of instant messaging that includes: receiving at a terminal a first message from a sender to a recipient; selecting a reply message from a plurality of messages in accordance with at least one predetermined criterion; and responding to the sender with the reply message; wherein selecting the reply message and responding to the sender are performed automatically by the terminal upon receiving the first message.

Yet another embodiment provides an instant messaging system that includes: a terminal for receiving a first message from a sender to a recipient; the terminal capable of operating in one of two response modes comprising an automatic mode and a manual mode; wherein operating in the automatic mode includes: (a) selecting a reply message from a plurality of messages in accordance with at least one predetermined criterion; and (b) responding to the sender with the selected reply message.

### BRIEF DESCRIPTION OF THE DRAWINGS

The teachings of the present invention can be readily understood by considering the following detailed description in conjunction with the accompanying drawings, in which:

FIG. 1 illustrates a method of instant messaging according to one embodiment of the present invention; and

FIG. 2 illustrates a system suitable for implementing the method of the present invention.

To facilitate understanding, identical reference numerals have been used, where possible, to designate identical elements that are common to the figures.

### DETAILED DESCRIPTION

The present invention relates to a method and system for instant messaging with automated responses and enhanced reply options.

In one embodiment, when a first message from a sender is received at a terminal, a reply message is selected from a plurality of pre-existing messages, e.g., messages with predetermined information content, and sent as a response to the sender. In another embodiment, the reply message is generated by selecting a template from a plurality of pre-existing message templates, and incorporating additional information in the template. The selection or generation of the particular reply message for use as the response is performed in an automated fashion, i.e., without intervention by the intended recipient of the first message at or after the time of receiving the first message. The information content of the reply message is selected or generated based on rules or policies set by the intended recipient prior to receiving the first message.

Each of the plurality of pre-existing messages may contain different information pertaining to various attributes of the recipient, and the specific reply message can be selected or generated according to different criteria such as the identity of the sender, time of receipt of the first message, appointment or work schedule of the recipient, or other factors that are determined or selected by the recipient. Such rule-based selection of reply messages provides enhanced reply options by allowing customized responses.

For example, a sender who is a business associate of the recipient may be sent an automated reply message with status information about the recipient that is appropriate for their relationship, while a sender who is a friend or relative of the recipient may be sent another reply message with different information.

Furthermore, the selection or generation of the automated reply message can be coupled to the recipient's calendar entries so that various details of the recipient's schedule can be inserted into a reply message template and sent as a response to certain senders.

The system is configured so that the automatic mode of selecting a reply message and responding to the sender can be activated by the user/recipient. Alternatively, the activation of the automatic mode may be coupled to a timer on keyboard activities, such that if the keyboard has been idle for a certain time period (that is predetermined by the user/recipient), the automatic response mode will be activated. Once activated, the automatic mode can also be overridden by the user to allow a direct or personal response to selective incoming messages or senders, while allowing the automatic mode to remain active for other senders.

In the automatic response mode, the system may also be configured such that incoming IMs will not be displayed at the recipient's terminal. Instead, they may be stored in a memory, either locally at the client's terminal or remotely at the IM server, for retrieval by the recipient at a later time.

In one embodiment, upon receiving the automated reply message, the sender may be given an option to indicate the priority level or degree of urgency of his first message, for example, by selecting from several pre-assigned priority levels, and sending this as a second message. If the priority level is higher than a threshold set by the intended recipient, the sender's first message may then be retrieved from memory, and presented to the recipient by displaying at the recipient's terminal.

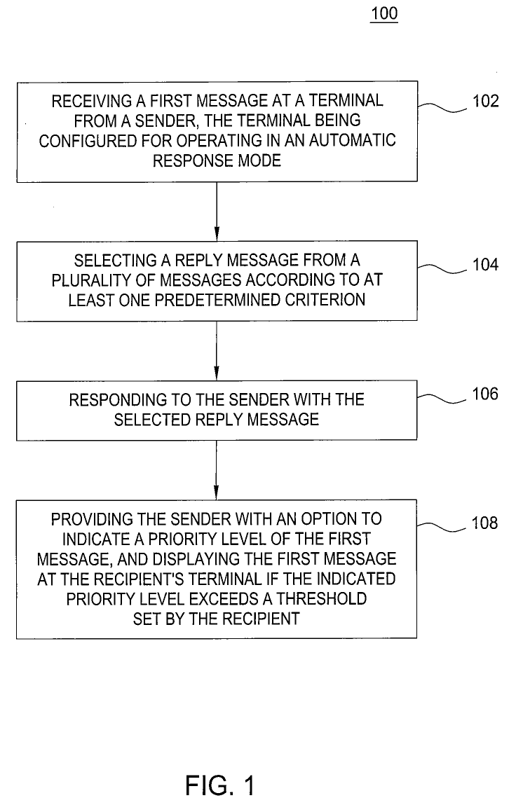

FIG. 1 illustrates a method 100 according to one embodiment of the present invention. In step 102, a message, e.g., instant text message, from a sender is received at a terminal configured for operating in an automatic response mode. The terminal may generally be any device configured for electronic communications, including for example, computers, personal digital assistants, phones, or other suitable devices. The intended recipient of the message may or may not be physically present at the terminal. As used herein, the term “message” includes communications via a variety of media, including text, video or audio.

In step 104, a reply message is selected from a collection of reply messages according to at least one predetermined criterion. The predetermined criteria, upon which the reply message (and thus, the information content) is selected and sent as a response to a sender, may relate to at least one of the following: the identity of the sender, the time when the first message is received (e.g., date, day of the week, or time of the day), the current or future availability status of the recipient, the scheduled activity of the user, the idle time of the keyboard or the terminal, or other relevant factors selected by the user.

The collection of reply messages may be stored in a message library in a memory associated with the terminal, or otherwise retrievable or accessible by the terminal. One or more stored messages are provided as “complete” responses, e.g., containing all the information that the IM recipient wants to convey to one or more senders. Others may be provided in the form of message templates, in which one or more information fields are to be completed, for example, with customized and/or time-dependent inputs, prior to being sent as a response. The collection of reply messages, which may be provided as part of the IM application software, can be customized by the IM user.

In step 106, the selected reply message is sent as a response to the IM sender. The selection of the specific reply message and responding to the sender are performed automatically by the terminal upon receiving the message.

In an optional step 108, the sender may be given an opportunity to indicate the priority level of the first message by sending a second message, for example, by indicating a priority level, such as a numerical scale from 1 to 5, in order of increasing importance. If the priority level is higher than a threshold set by the intended recipient, then the sender's first message may be displayed at the recipient's terminal.

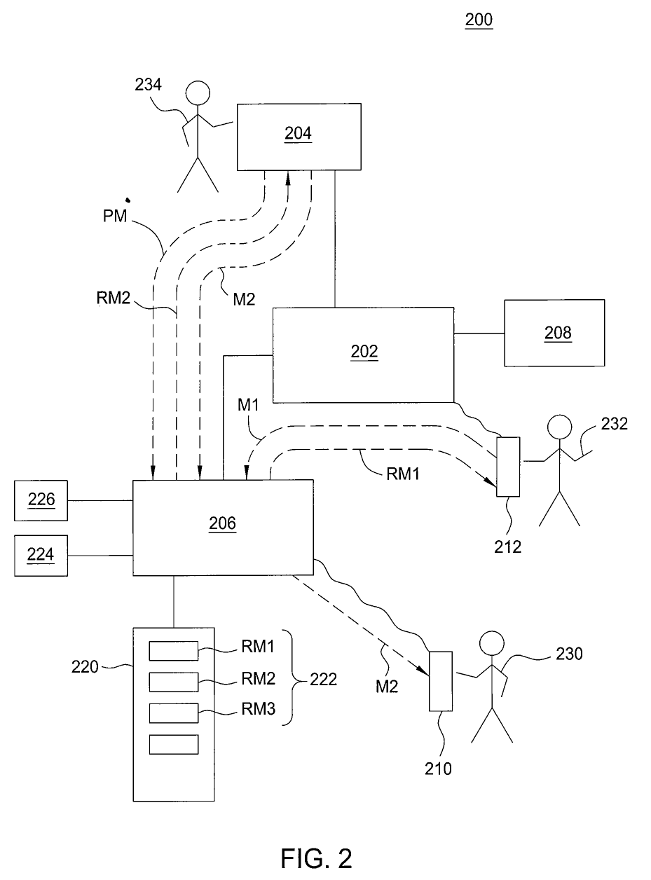

FIG. 2 illustrates a system that is suitable for implementing the method of this invention. The system includes a network 200 having a server 202 associated with a messaging service and a number of communication devices or terminals such as 204, 206, 208, 210 and 212. These communication terminals generally include computers, personal digital assistants, telephones, and other devices, which may be mobile or desktop units. These terminals can be configured to operate in one of two response modes: a standard or manual response mode and an automatic response mode. The automatic response mode may be activated as the only response mode, or be activated concurrently with the manual mode.

They may be directly connected to the server 202 through one communication network, or indirectly via other devices or network connections, including landlines and wireless networks. Thus, a user 230, who is logged on to the IM server 202 at terminal 206, may communicate with terminal 206 from a remote device 210 (without logging on to server 202 directly) to review or change the settings relating to the IM service.

As shown in FIG. 2, terminal 206 is coupled to a memory 220, which contains a message library 222 belonging to, or associated with, an IM user 230. The term “memory”, as used throughout this discussion, is meant to include different forms of storage or computer-readable media, such as random access memory (RAM), optical discs, magnetic storage, among others. Information or data may be stored in memory in different file structures or formats, including databases, spreadsheets, text files, multimedia files, and so on, using a variety of software applications. Terminal 206 is also provided with access to a contact list or address book 224, and a calendar 226 containing the appointment schedule of user 230. The contact list 224 and calendar 226 may reside in a memory within terminal 206 or stored in another memory accessible by terminal 206, including memory 220. The message library 222 contains a plurality of messages, RM1, RM2, RM3, . . . , etc., each with different information relating to the user 230, such as his availability status, current or future schedules of activities, or other information as determined by user 230.

In one embodiment, one or more stored messages may be associated with one or more IM users in a predetermined list, e.g., previously set up by user 230 as being suitable as a response message to certain IM users, or different categories of users. For example, RM1 may be associated with IM users who are business associates of user 230, RM2 may be associated with family members of user 230, while RM3 may be associated with a particular individual whom user 230 has previously identified.

An IM user 232 sends a message M1 from his device 212 to terminal 206, with user 230 being the intended recipient. In one embodiment, the terminal 206 is configured such that, upon the arrival or receipt of message M1, the message library 222 in memory 220 is automatically accessed. Depending on the identity of user 232 and the predetermined criteria or rules, a reply message is selected by terminal 206 and sent as a response to user 232. For example, if user 232 is classified as a business associate in an address book or contact list for user 230, reply message RM1 is selected by terminal 206 and sent to user 232. Under the automatic response mode, terminal 206 may be configured to either display incoming message M1 at the terminal, or omit the display and store message M1 in a memory, e.g., memory 220, for later retrieval.

Another user 234, who is a family member of user 230, may send a message M2 from terminal 204 to terminal 206 for user 230. Upon receiving message M2, terminal 206 determines that user 234 belongs to the category of “family” in the address book or contact list 224, and a reply message RM2 is selected and sent by terminal 206 as a response to user 234.

Terminal 206 may optionally be configured such that the response message RM2 instructs user 234 to indicate a priority level of his message M2. If the priority level indicated by user 234, e.g., via another message PM to terminal 206, is at least equal to a predetermined threshold set by user 230, then message M2 is displayed at terminal 206 for review by user 230. Optionally, terminal 206 may also be configured to forward message M2 to a device 210 carried by user 230 at a remote location.

Alternatively, one or more messages in the message library may be associated with the schedule or activities of the user 230, as indicated by the calendar entries of user 230. For example, RM3 may be a message template associated with a particular activity such as a meeting, and may contain the text with a blank field to be completed for the time: “User 230 is at a meeting with ______, and will respond to you after ______.” If an incoming message is received during a scheduled meeting, as indicated on the calendar 226 of user 230, terminal 206 selects message RM3 and insert the appropriate information e.g., the meeting attendee, meeting end time, into the blank fields of message RM3. The completed message will then be sent as a response to the sender. Other message templates with different fields can be stored in the message library, and a response with appropriately customized information can be sent by terminal 206.

Terminal 206 can be activated exclusively for automatic response mode (e.g., automatic responses sent for all incoming messages or within a certain time period), or be activated for both automatic and manual response mode. For example, automatic mode can be used for all senders within the IM network or within a certain time frame, regardless of whether user 230 is physically present at terminal 206 when a message arrives.

Alternatively, automatic responses may only be used on a selective basis, e.g., based on at least one factor such as the sender's identity, time of receipt of an incoming message, the schedule or activities of user 230, among others. Thus, user 230 may activate both automatic and manual response modes, but terminal 206 will only operate under automatic mode for incoming messages from one or more individuals that are pre-identified, while the manual or standard response mode will operate for messages from a specific individual or another subset of users, such that their IMs are displayed at the terminal 206 upon receipt for manual response.

The automatic response mode can also be activated according to the user's calendar entries or activities at the time of receipt of the IM. For example, if user 230 is occupied in a one-on-one meeting or phone call, terminal 206 may operate in the automatic response mode to avoid disturbing the user. On the other hand, if user 230 is in a group meeting, IMs from one or more previously identified senders may be allowed to be displayed at terminal 206 in the standard mode for manual response. Alternatively, terminal 206 can also be configured to activate the automatic mode based on a lack of keyboard activities, e.g., idle time, at the terminal.

Embodiments of the invention can be implemented either at the client side or at the IM server side. For example, enhanced options and added capacity can be provided to a client to provide automated response messages to various parties in one or more IM sessions. This may be added as an “extension module” in IM clients that support such architecture, and may be well-suited for peer-to-peer communications sessions.

Alternatively, implementation can be done as a server side feature that is customizable by the user. In this case, the server applies the defined logic to inbound communications or session requests and maintains a log of received messages for the user to access at a later time.

Those skilled in the art would be able to come up with creative ways of distributing this functionality between client and server components.

Even though embodiments of this invention are discussed in the context of one-on-one instant messaging, they can also be adapted to other presence-based applications, including group chat or push-to-talk, in which case, the reply messages can be tailored to the applicable communication context or medium.

The following examples further illustrate how various reply messages may be customized to different users under different scenarios.

### EXAMPLE 1

John, a colleague of Jane, sends an IM intended for Jane, and gets a response: “Jane is in a meeting with Ken, she will respond when she returns.” The system is configured in automatic mode such that the reply message is automatically selected from a number of predetermined messages and sent to John, without any intervention from Jane, and regardless of whether she is present at the IM terminal or not. Furthermore, the information “in a meeting with Ken” may be a customizable or time-dependent field that is coupled to Jane's calendar and accessible by Jane's terminal. Based on the time of receipt of John's incoming message, the appropriate information retrieved from Jane's calendar can be inserted into the reply message.

John may then be invited to rate the priority of his first message within a predefined range of discrete values, e.g., by being presented with an option on his terminal to select a priority setting. If the message is ranked sufficiently high in priority so as to be equal to or surpass a “visibility threshold” previously set by Jane, John's first message will be presented to Jane, either at the original destination terminal, or be forwarded to her at another terminal. Otherwise, the message will be stored in a memory, e.g., an off-line folder, for Jane's review at a later time. Jane can also set her visibility threshold to forbid any messages from disturbing her.

Meanwhile, Keith, Jane's husband, sends a message to Jane, and gets an automatic response: “In a meeting with Ken. Will leave work at about 7:30 pm, and pick up pizza for dinner.” The information regarding the meeting with Ken is retrieved by Jane's terminal from her calendar.

Once the meeting is over, Jane can peruse her off-line messages, which can be ordered either by time or by importance as indicated by their respective senders. When she sets her status to available, the individuals that contacted her while she was busy may be automatically notified of the change in availability as defined by Jane's privacy policies or rules.

### EXAMPLE 2

In another scenario, Jane's terminal is configured so that both automatic and manual response mode are activated. Jane is on the phone speaking to a customer, and her son, John, sends her a message. A response is automatically sent to John because he is one of those IM users designated by Jane for automatic response: “Will get back to you soon after phone call.” Meanwhile, Michael, her supervisor, sends her a message, which is displayed on her terminal because Michael is designated as a user for standard or manual response mode. Jane responds to Michael directly from her terminal.

### EXAMPLE 3

IM user Jack is in a bad mood (indicated by his published presence information or status message), acquaintances that send him instant messages might get back an automated reply IM saying “Jack will respond later,” while close friends might get a different reply IM with more information, e.g., “recovering from a root-canal, don't feel like chatting right now.”

Jack's settings for automated responses can be used repeatedly for a predetermined period or throughout the lifetime of the application, so that whenever Jack is in a meeting or feels a toothache again, the system will select the same automatic reply messages according to the accompanying policies or rules.

While embodiments of the present invention can generally be applied to any IM applications or systems, it may provide particular benefits in a business or corporate environment. Thus, integration of the present invention with existing appointment trackers and IM solutions present in high end personal digital assistants and smartphones may be of special interest.

While the foregoing is directed to embodiments of the present invention, other and further embodiments of the invention may be devised without departing from the basic scope thereof, and the scope thereof is determined by the claims that follow.

1. A method of instant messaging, comprising:
receiving at a terminal a first message from a sender to a recipient; the terminal capable of operating in one of two response modes comprising an automatic mode and a manual mode;
selecting one of the two response modes based on at least one factor; and
responding to the sender by the selected response mode;
wherein operating in the automatic response mode comprises:
(a) selecting a reply message from a plurality of messages in accordance with at least one predetermined criterion; and
(b) responding to the sender with the reply message;
wherein steps (a) and (b) are performed automatically by the terminal upon receiving the first message.

2. The method of claim 1, wherein the at least one factor comprises at least one of an identity of the sender, a time the first message is received, a current availability status of the recipient, a future availability status of the recipient, and an idle time of the terminal.

3. The method of claim 1, wherein the at least one predetermined criterion comprises at least one of an identity of the sender, a time the first message is received, a current availability status of the recipient, a future availability status of the recipient, and an idle time of the terminal.

4. The method of claim 1, wherein operating in the automatic mode further comprises:
(c) prior to responding to the sender, customizing the selected reply message by including information from a current calendar entry of the recipient.

5. The method of claim 1, wherein operating in the automatic mode further comprises:
(d) suppressing display of at least the first message at the terminal; and
(e) storing the first message in a memory.

6. The method of claim 5, wherein operating in the automatic mode further comprises:
(f) requesting the sender to indicate a priority level of the first message;
(g) receiving a second message from the sender indicating the priority level of the first message; and
(h) displaying the first message at the terminal if the indicated priority level is at least equal to a predetermined priority threshold.

7. A method of instant messaging (IM), comprising:
receiving at the terminal a first message from a sender to a recipient;
selecting a reply message from a plurality of messages in accordance with at least one predetermined criterion; and
responding to the sender with the reply message;
wherein selecting the reply message and responding to the sender are performed automatically by the terminal upon receiving the first message.

8. The method of claim 7, wherein the at least one predetermined criterion comprises at least one of an identity of the sender, a time the first message is received, a current availability status of the recipient, a future availability status of the recipient, and an idle time of the terminal.

9. The method of claim 7, further comprising:
customizing the selected reply message by including information from a current calendar entry of the recipient.

10. The method of claim 7, further comprising:
providing a default configuration of the terminal to suppress display of all received messages;
requesting the sender to indicate a priority level of the first message;
receiving a second message from the sender indicating the priority level of the first message;
overriding the default configuration by displaying the first message if the indicated priority level is at least equal to a predetermined priority threshold, and
storing the first message in a memory if the indicated priority level is less than the predetermined priority threshold.

11. An instant messaging system, comprising:
a terminal for receiving a first message from a sender to a recipient;
the terminal capable of operating in one of two response modes comprising an automatic mode and a manual mode;
wherein operating in the automatic mode comprises:
(a) selecting a reply message from a plurality of messages in accordance with at least one predetermined criterion; and
(b) responding to the sender with the selected reply message.

12. The instant messaging system of claim 11, wherein the at least one predetermined criterion comprises at least one of an identity of the sender, a time the first message is received, a current availability status of the recipient, a future availability status of the recipient, and an idle time of the terminal.

13. The instant messaging system of claim 11, wherein the terminal is provided with access to at least one of a contact list and a calendar of the recipient.

14. The instant messaging system of claim 13, wherein the terminal is configured to operate in one of the two response modes based on at least one factor selected from identity of the sender, time of receiving the first message, availability status of the recipient, and combinations thereof.
